(19) United States
(12) Patent Application Publication
(10) Pub. No.: US 2014/0365106 A1
(43) Pub. Date: Dec. 11, 2014

(54) Method For Collecting And Processing Relative Spatial Data

(71) Applicant: International Business Machines Corporation, Armonk, NY (US)

(72) Inventors: Michael B. Litherland, Cleveland Heights, OH (US); Ivan M. Milman, Austin, TX (US); Martin Oberhofer, Bondorf (DE); Donald A. Padilla, Albuquerque, NM (US)

(21) Appl. No.: 13/913,705

(22) Filed: Jun. 10, 2013

(51) Int. Cl. G01C 21/00

(52) U.S. Cl. CPC G01C 21/00
USPC 701/300

(57) ABSTRACT

A method and system are disclosed for determining relative connectedness from temporal data. A user iterates through a list of items implemented on a mobile device. As each item on the list is located it is marked to generate a corresponding timestamp. The timestamps are then used to generate a timestamped list, which in turn is processed to determine the amount of elapsed time between each item on the list being located. The timestamped list data is then processed to generate relative connectedness data, which in turn is processed to generate a relative connectedness graph. The relative connectedness graph is then processed to assign coordinates to each item on the list. In turn, the coordinates are used to generate a map of the items.

### BACKGROUND OF THE INVENTION

1. Field of the Invention

The present invention relates in general to the field of computers and similar technologies, and in particular to software utilized in this field. Still more particularly, it relates to a method and system for determining relative connectedness from temporal data.

2. Description of the Related Art

Humans and computers consider and process spatial data in fundamentally different manners, which can be respectively summarized as relative and coordinate-based. For example, a human may remember that his watch is on his desk in his office on the second floor of his home, while a computer would typically store such information as being ‘X’ distance South, ‘Y’ distance East, and ‘Z’ distance vertically from a predetermined point. In some computer graphics systems, a hybrid approach of scene graphs are used, but only as a method to organize data for users and rendering engines. As a result, even though these systems may share some features of a relative spatial data organization that humans find familiar, the underlying organization is still based on coordinate systems.

Computer systems are proficient in using coordinates to specify the position of an object. As an example, “pick and place” robotic systems use an item's source and destination coordinates to describe where an item is and where it needs to go. Such systems typically use an optimized list of items to reduce traversal times and achieve increased efficiency. However, these same systems are less proficient at locating objects in the absence of instrumentation needed to support precise positioning, which typically includes most places that humans interact with objects.

In contrast, humans are proficient in navigating their environments using an understanding of objects that may be placed in proximity to one another. Though they may not always choose an optimal approach to navigation, they can factor intangible information that is difficult for computer systems to glean from raw data. For example, a human may decide not to follow a GPS's navigation directions in order to avoid a neighborhood with a high crime rate or simply to pick a route with a more scenic view. It is also common for humans to navigate from a list, such as a shopping list or a list of locations to perform errands. However, there is currently no known approach to automating the provision of a list that is optimized according to the relative spatial location of the items it contains.

### SUMMARY OF THE INVENTION

A method and system are disclosed for determining relative connectedness from temporal data. In various embodiments, a user iterates through a list of items (e.g., a shopping list) implemented on a mobile device, such as a smart phone or tablet computer. As each item on the list is located it is either scanned or marked on the list by the user, which results in the generation of a corresponding timestamp. These timestamps, which include temporal data, are then respectively appended to each item to generate a timestamped list.

The resulting timestamped list is then processed to determine the amount of elapsed time between each item on the list being located by the user. During the processing, timestamped list data associated with large timestamp intervals are discarded, as they indicate items that are unlikely to be in close proximity to one another. The remaining timestamped list data is then processed to generate relative connectedness data, which in turn is processed to generate a relative connectedness graph. The relative connectedness graph is then processed to assign coordinates to each item on the list. In turn, the coordinates are used to generate a map of the items.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified spatial map of items on a list generated from temporal data provided by a user;

FIG. 3 is a simplified spatial map of a physical site;

FIG. 4 is a simplified graph of randomized lists for sequentially locating a subset of the items depicted in the map of FIG. 3;

FIGS. 5a and 5b show one grouping of the individual items depicted in the simplified graph of FIG. 4 into a plurality of subgraphs;

FIG. 6 shows another grouping of the individual items depicted in the simplified graph of FIG. 4 into a plurality of subgraphs;

FIG. 7 shows yet another grouping of the individual items depicted in the simplified graph of FIG. 4 into a plurality of subgraphs;

FIG. 8 shows still yet another grouping of the individual items depicted in the simplified graph of FIG. 4 into a plurality of subgraphs; and

FIGS. 9a and 9b are a generalized flowchart of operations for performing relative connectedness graphing operations.

### DETAILED DESCRIPTION

A method and system are disclosed for determining relative connectedness from temporal data. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

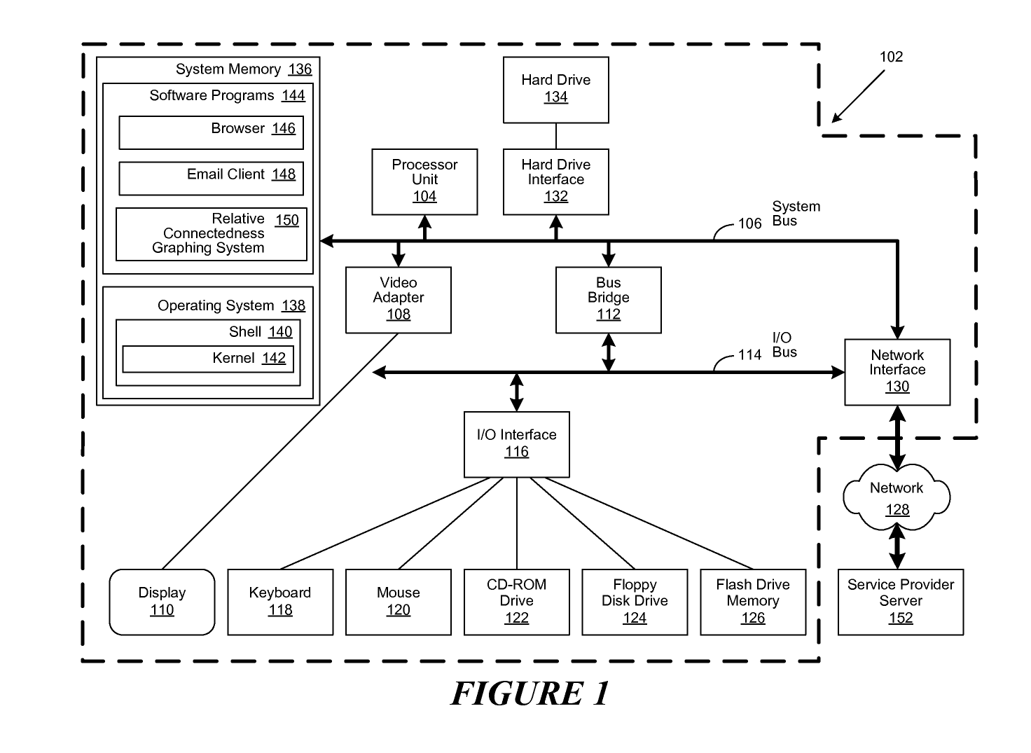

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include a relative connectedness graphing system 150. In these and other embodiments, the relative connectedness graphing system 150 includes code for implementing the processes described hereinbelow. In one embodiment, client computer 102 is able to download the relative connectedness graphing system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

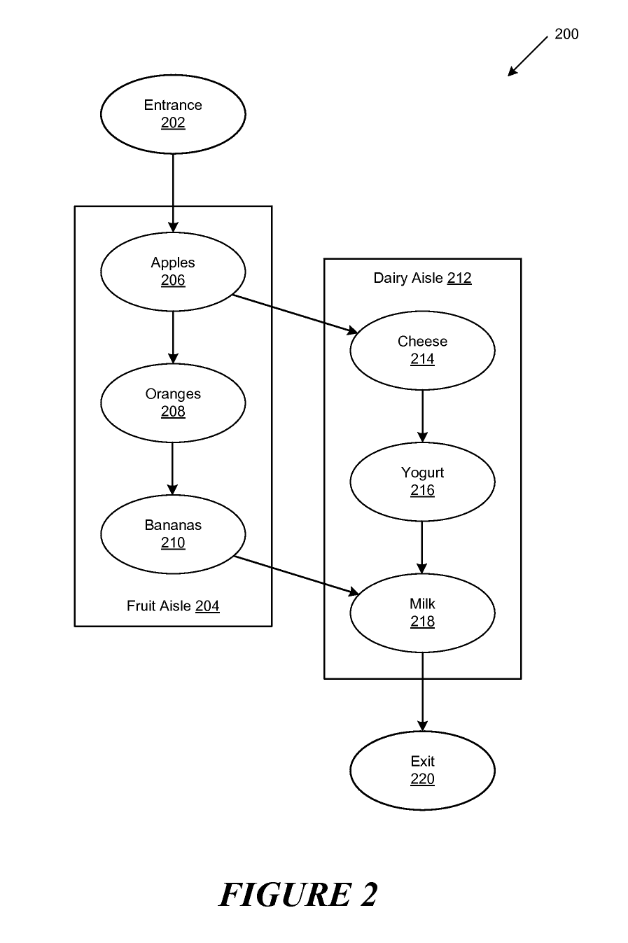

FIG. 2 is a simplified spatial map of items on a list generated in accordance with an embodiment of the invention from temporal data provided by a user. In various embodiments, a user iterates through a list of items (e.g., a shopping list) implemented on a mobile device, such as a smart phone or tablet computer. As each item on the list is located it is either scanned or marked on the list by the user, which generates a corresponding timestamp. These timestamps, which include temporal data, are then respectively appended to each item to generate a timestamped list. In various embodiments, the user's mobile device is implemented with instrumentation capabilities to provide, and subsequently process, the temporal data to generate the timestamped list.

The resulting timestamped list is then processed to determine the amount of elapsed time between each item on the list being located by the user. In various embodiments, the user's mobile device is used to provide the timestamped list for processing. During the processing, timestamped list data associated with large timestamp intervals are discarded, as they indicate items that are unlikely to be in close proximity to one another. The method of determining the value of the large timestamp intervals is a matter of design choice. The remaining timestamped list data is then processed to generate relative connectedness data, which in turn is processed to generate a relative connectedness graph. The relative connectedness graph is then processed to assign coordinates to each item on the list. In turn, the coordinates are used to generate a map of the items. In various embodiments, the relative connectedness graph is used to convert relative location information to coordinate-based location information and back again. As used herein, a graph refers to a mathematical construct familiar to those of skill in the art.

Referring now to FIG. 2, a physical site has an entrance 202, a fruit aisle 204, a dairy aisle 212, and an exit 220. The fruit aisle 204 contains apples 206, oranges 208, and bananas 210, while the dairy aisle 212 contains cheese 214, yogurt 216, and milk 218. In this embodiment, a first user creates a list of items on a mobile device:

apples 206
oranges 208
milk 218

The first user then navigates to the entrance 202 of the physical site 200 to begin locating the items on their list. As each item is located it is either scanned or marked on the list by the first user, which results in the generation of a corresponding timestamp. These timestamps, which include temporal data, are then respectively appended to each item to generate a timestamped list:

| | |
|---|---|
| apples 206 | 17:35:00 PM |
| oranges 208 | 17:35:15 PM |
| milk 218 | 17:37:30 PM |

The user then uses their mobile device to provide the timestamped list for processing to determine which items are likely to be near one another. For example, the timestamp interval between locating the apples 206 and locating the oranges 208 was 15 seconds, implying that they are likely close to one another. During the processing of the timestamped list, timestamped list data associated with large timestamp intervals are discarded, as they indicate items that are unlikely to be in close proximity to one another. As an example, the timestamp interval between locating the oranges 208 and locating the milk 218 is 2 minutes and 15 seconds. Therefore, the timestamp data associated with the milk 218 is discarded since it is unlikely that the milk 218 is located close to the oranges 208 or apples 206. The method of determining the value of the large timestamp interval is a matter of design choice.

As described in greater detail herein, the remaining timestamp intervals are then processed to generate relative connectedness data, which in turn is processed to generate a relative connectedness graph. The relative connectedness graph turn is then processed to assign coordinates to each item on the list. In turn, the coordinates are used to generate a map of the items within the physical site 200. Over time, other users provide their respective timestamped lists, which are likewise processed to improve the accuracy and coverage of the map. Those of skill in the art will recognize that errors and inefficiencies in the generation of the map can be reduced over time as new timestamped list data is received and processed.

For example, processing various timestamped lists may establish that the timestamp interval between locating the oranges 208 and locating the bananas 210 averages 10 seconds. Therefore, proximity is established for apples 206, oranges 208, and bananas 210. In one embodiment, the proximity of the apples 206, oranges 208, and bananas 210, all of which are fruit, implies that these items are located on a fruit aisle 204. To continue the example, a second user may have created the following list of items on their connected device:

apples 206
cheese 214
yogurt 216
milk 218

After locating the apples 206 on the fruit aisle 204, the second user can be informed that the cheese 214 is on the dairy aisle 212, which is proximal to the fruit aisle 204. Once the cheese 214 is located, the second user can then be informed that both the yogurt 216 and the milk 218 are on the dairy aisle 212 as well. Once all items on the list are located, the second user leaves the physical site through exit 220. In various embodiments, a coordinate system can be imposed upon the map of the physical site 200 for robotic or other computer-assisted navigation. Skilled practitioners of the art will recognize that the invention has many possible applications and that the foregoing grocery shopping metaphor is not intended to limit the spirit, scope or intent of the invention.

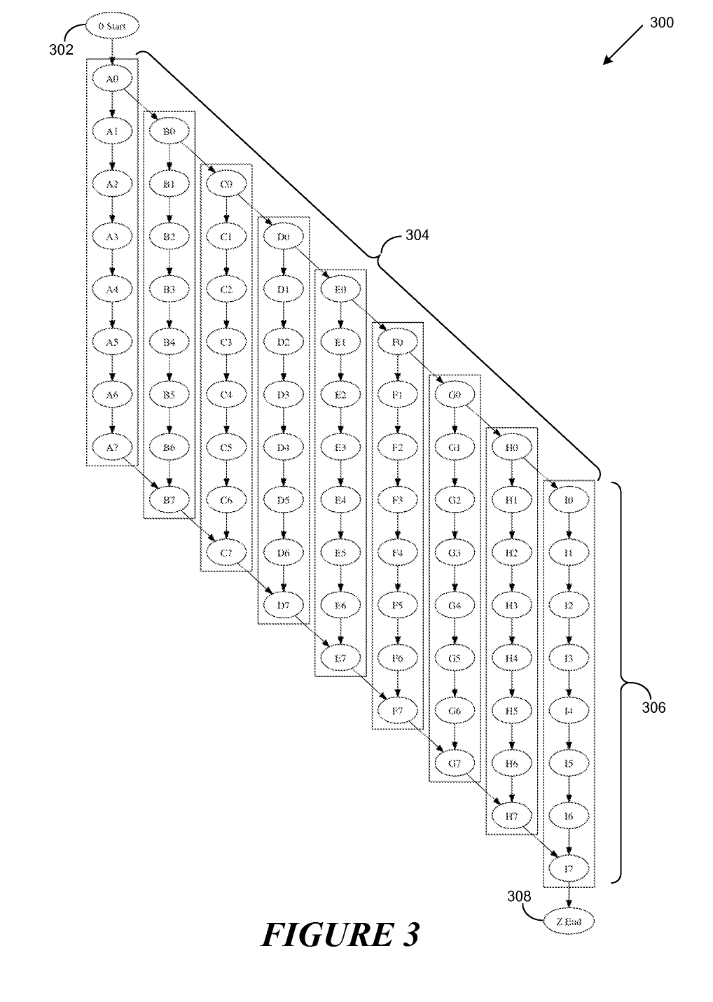

FIG. 3 is a simplified spatial map of a physical site implemented in accordance with an embodiment of the invention. In this embodiment, the physical site 300 includes a starting point 302, an ending point 308, nine aisles ‘A’ through ‘I’ 304, each of which includes eight items ‘0’ through ‘7’ 306. For simplicity, it is assumed that the items ‘0’ through ‘7’ 306 are accessible from both sides of aisles ‘A’ through ‘I’ 304.

As described in greater detail herein, computing systems typically process spatial data as a series of Cartesian coordinates. Humans, however, use the much more flexible concept of relative placement—the pencils are near the phone, the milk is near the Ranch Dressing in the refrigerator. Furthermore, implementing Cartesian-based systems is undesirable in many situations due to their intrinsic cost and complexity. For example, wiring a retail store or warehouse, such as physical site 300, with indoor telemetry equipment that could be used by robotic or human-interfacing computers could be prohibitively difficult, costly, or both.

In various embodiments, as likewise described in greater detail herein, human-facing list systems are instrumented with a coordinate system to provide both coordinate-based and relative placement descriptions of item locations. In these embodiments, the item locations are determined through the use of modest computing resources typically associated with mobile devices.

In various embodiments, these item locations are expressed as a mathematical graph. As shown in FIG. 3, the graph may be rendered as a directed graph. However, direction information is not relevant to the information represented except in the case of randomized shopping trips described in greater detail herein. Furthermore, in certain embodiments, the graphs can be combined with coordinates to improve accuracy. As a result, graphs of environments, such as the physical site 300 shown in FIG. 3, benefit from human intelligence and can be used to provide an approach to various graph problems. As an example, with repeated navigation, humans typically find relatively efficient ways to traverse the distance separating the location of two items. If the time to traverse the distance is recorded, and the velocity of the traversal can be estimated, then the relative connectedness of the two items can be determined.

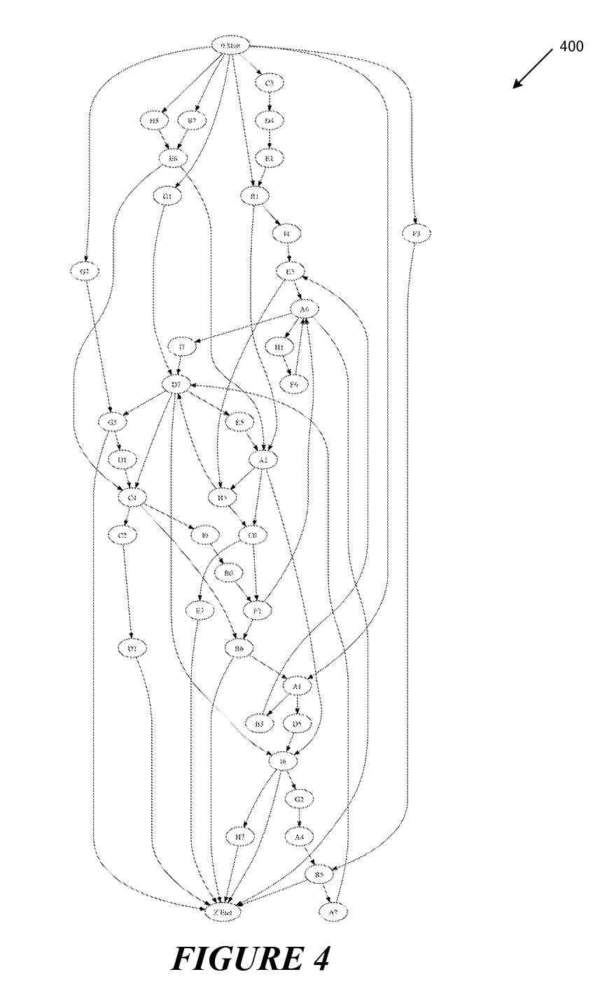

FIG. 4 is a simplified graph of randomized lists implemented in accordance with an embodiment of the invention for sequentially locating a subset of the items depicted in the map of FIG. 3. In this embodiment, a plurality of randomized lists (e.g., 1,000) are generated, each of which contain a subset of the 72 available items depicted in the map of FIG. 3. The randomized lists are then assigned to a predetermined number of users, who in turn use the randomized lists to sequentially locate the items they contain. For clarity, only eight of the randomized lists are shown in FIG. 4.

As each item on the randomized list is located, it is either scanned or marked on the list by the user, which generates a corresponding timestamp. These timestamps, which include temporal data, are then respectively appended to each item in the randomized list to generate a timestamped randomized list. An example of a timestamped randomized list is as follows:

NodeStep {node = Node {nodeName = “G4”, col = 6, row = 4}, nodePrev =

Node {nodeName = “0 Start”, col = −1, row = −1}, timeStep = 85.0,
timeTotal = 85.0}

NodeStep {node = Node {nodeName = “H4”, col = 7, row = 4}, nodePrev =

Node {nodeName = “G4”, col = 6, row = 4}, timeStep = 40.0,
timeTotal = 125.0}

NodeStep {node = Node {nodeName = “F2”, col = 5, row = 2}, nodePrev =

Node {nodeName = “H4”, col = 7, row = 4}, timeStep = 60.0,
timeTotal = 185.0}

NodeStep {node = Node {nodeName = “F1”, col = 5, row = 1}, nodePrev =

Node {nodeName = “F2”, col = 5, row = 2}, timeStep = 5.0,
timeTotal = 190.0}

NodeStep {node = Node {nodeName = “D4”, col = 3, row = 4}, nodePrev =

Node {nodeName = “F1”, col = 5, row = 1}, timeStep = 45.0,
timeTotal = 235.0}

NodeStep {node = Node {nodeName = “E7”, col = 4, row = 7}, nodePrev =

Node {nodeName = “D4”, col = 3, row = 4}, timeStep = 25.0,
timeTotal = 260.0}

NodeStep {node = Node {nodeName = “C2”, col = 2, row = 2}, nodePrev =

Node {nodeName = “E7”, col = 4, row = 7}, timeStep = 45.0,
timeTotal = 305.0}

NodeStep {node = Node {nodeName = “D2”, col = 3, row = 2}, nodePrev =

Node {nodeName = “C2”, col = 2, row = 2}, timeStep = 30.0,
timeTotal = 335.0}

NodeStep {node = Node {nodeName = “A5”, col = 0, row = 5}, nodePrev =

Node {nodeName = “D2”, col = 3, row = 2}, timeStep = 65.0,
timeTotal = 400.0}

NodeStep {node = Node {nodeName = “Z End”, col = 8, row = 8}, nodePrev =

Node {nodeName = “A5”, col = 0, row = 5}, timeStep = 85.0,
timeTotal = 485.0}

As shown above, each step of the example randomized list encodes the current item (“node”), the previous item, the time it took to navigate between them, and the total time of the randomized list at that step. During processing, all information is discarded except the name of the items and the length of the time step. In this embodiment, a simple algorithm is implemented to compute the time steps where traversing items within an aisle takes five seconds and traversing an aisle takes ten seconds when the user is at the end of an aisle as depicted in FIG. 3. As likewise depicted in FIG. 3, the user travels to the end of the next closest aisle when the next item on the randomized list is not in the current aisle.

From the foregoing, it will be appreciated that little useful information can be gleaned from this excess of information, excluding perhaps which items are most popular. Certainly no useful information regarding the location of items, either relatively or absolutely, can be determined. However, as described in greater detail herein, additional information regarding the arrangement of items in the physical site 300 of FIG. 3 can be combined with the graph 400 shown in FIG. 4.

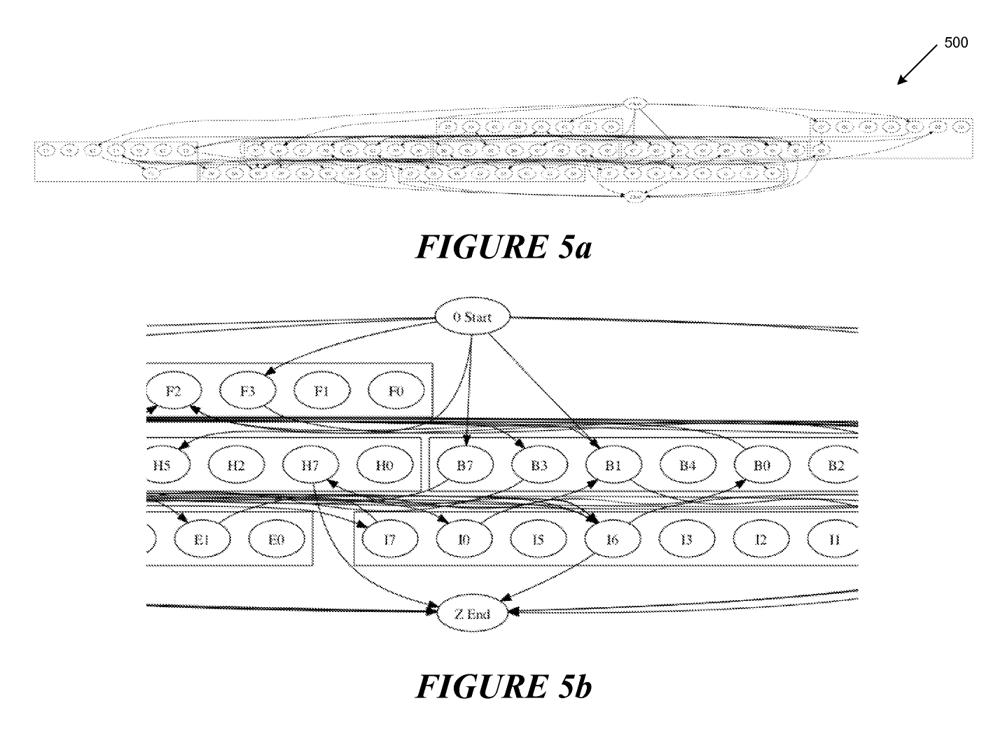

FIGS. 5a and 5b show one grouping of the individual items depicted in the simplified graph of FIG. 4 into a plurality of subgraphs implemented in accordance with an embodiment of the invention. As shown in FIG. 5a, the individual items depicted in the simplified graph of FIG. 4 have been grouped into a plurality of subgraphs 500, each of which correspond to a predetermined aisle ‘A’ through ‘I’ 304 depicted in FIG. 3. FIG. 5b shows a cropped view of FIG. 5a for additional clarity. However, this cropped view of the graph data shown in FIG. 5a reveals that very little of the intrinsic structure of the data is apparent without performing additional processing of the data resulting from the randomized list operations depicted in FIG. 4.

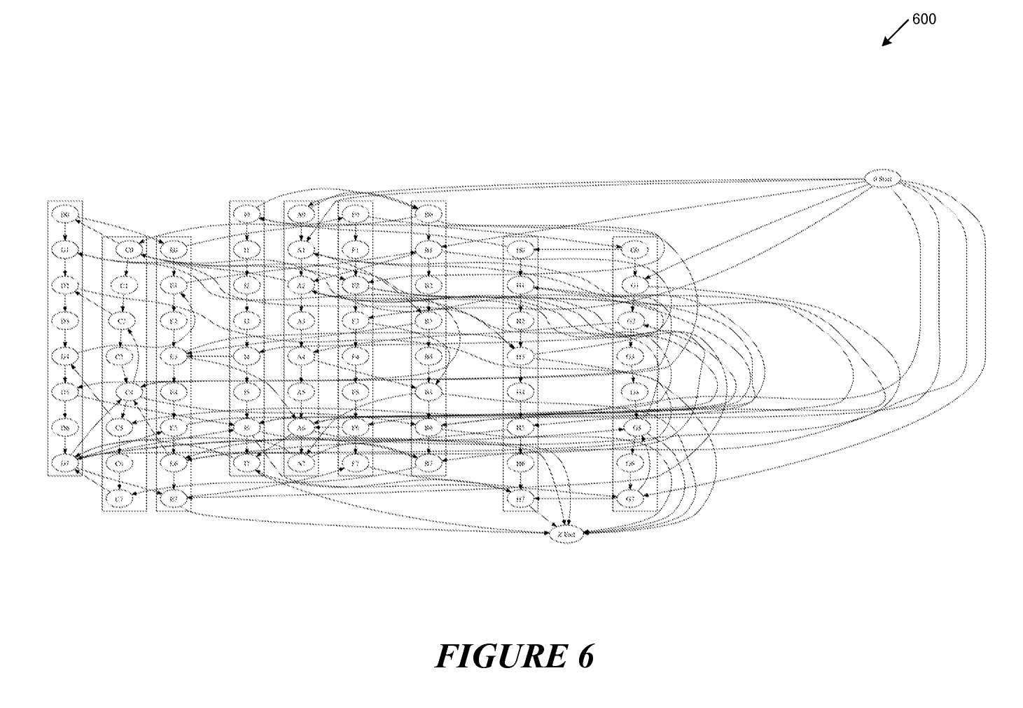

FIG. 6 shows another grouping of the individual items depicted in the simplified graph of FIG. 4 into a plurality of subgraphs implemented in accordance with an embodiment of the invention. In this embodiment, the order of the items within each aisle ‘A’ through ‘I’ 304 depicted in FIG. 3 is added to the graph shown in FIG. 5. As shown in FIG. 6, the randomized list navigation data simply results in a confused graph where it is not possible to determine which order the aisles would be in ordinarily, despite the foreknowledge that the aisles ‘A’ through ‘I’ 304 are depicted in alphabetical order in FIG. 3. For example, aisle ‘B’ is shown to be located between aisle ‘F’ and ‘H’ in the subgraphs 600 instead of between aisle ‘A’ and ‘C’ as depicted in FIG. 3. Furthermore, as shown in FIG. 6, humans would not be able to navigate across the aisles ‘A’ through ‘I’ 304 depicted in FIG. 3 as shown by the subgraphs 600 in FIG. 6.

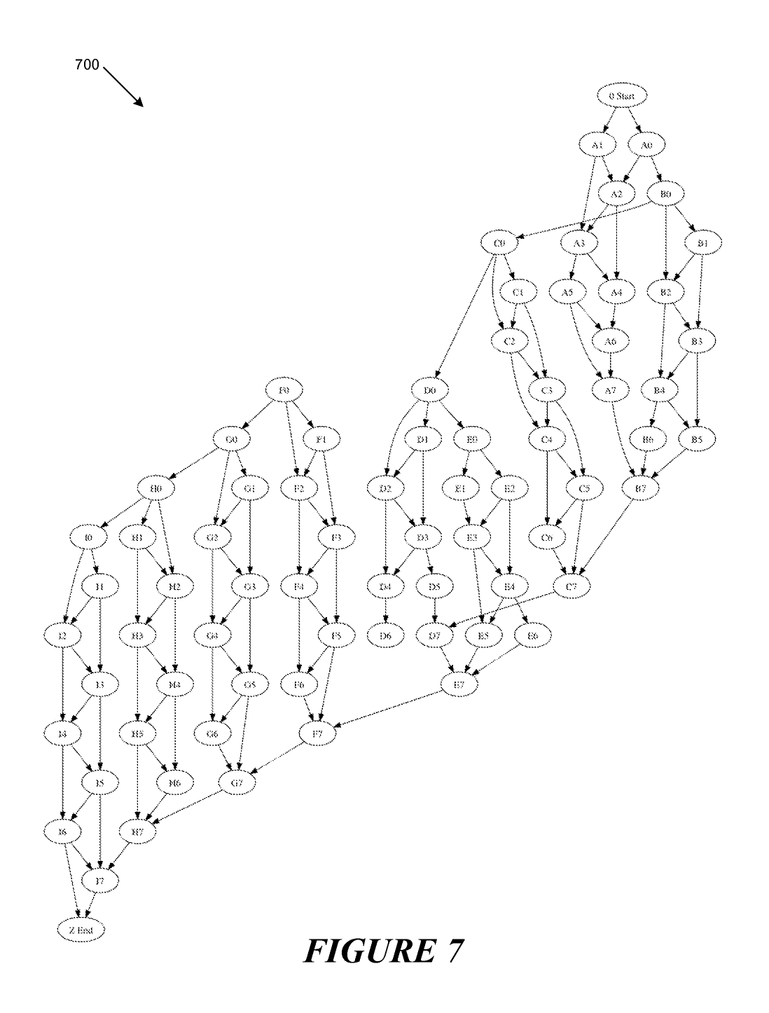

FIG. 7 shows yet another grouping of the individual items depicted in the simplified graph of FIG. 4 into a plurality of subgraphs implemented in accordance with an embodiment of the invention. Skilled practitioners of the art will recognize that working with data in the form of a graph poses both challenges and advantages. While existing algorithms for graph data (e.g., “optimal” navigation algorithms) may be used, graphs become more and more complex as the number of nodes increases. Therefore, it is advantageous for algorithms dealing with graph data to be able to process incoming data in linear time.

This issue is addressed in various embodiments by implementing an algorithm that discards data where the time step interval exceeds a predetermined value. In this embodiment, the time step interval value is selected to be equivalent to the hypotenuse of the minimal intra-aisle/inter-aisle navigation, or sqrt(5̂2+10̂2). As a result, the subgraphs 700 shown in FIG. 7 provide the ability for a human to navigate the aisles ‘A’ through ‘I’ depicted in FIG. 3. However, the order of the items within each of the aisles ‘A’ through ‘I’ 304 depicted in FIG. 3 is not accurately depicted. As an example, it is not clear that item ‘A1’ is between items ‘A0’ and ‘A2.’

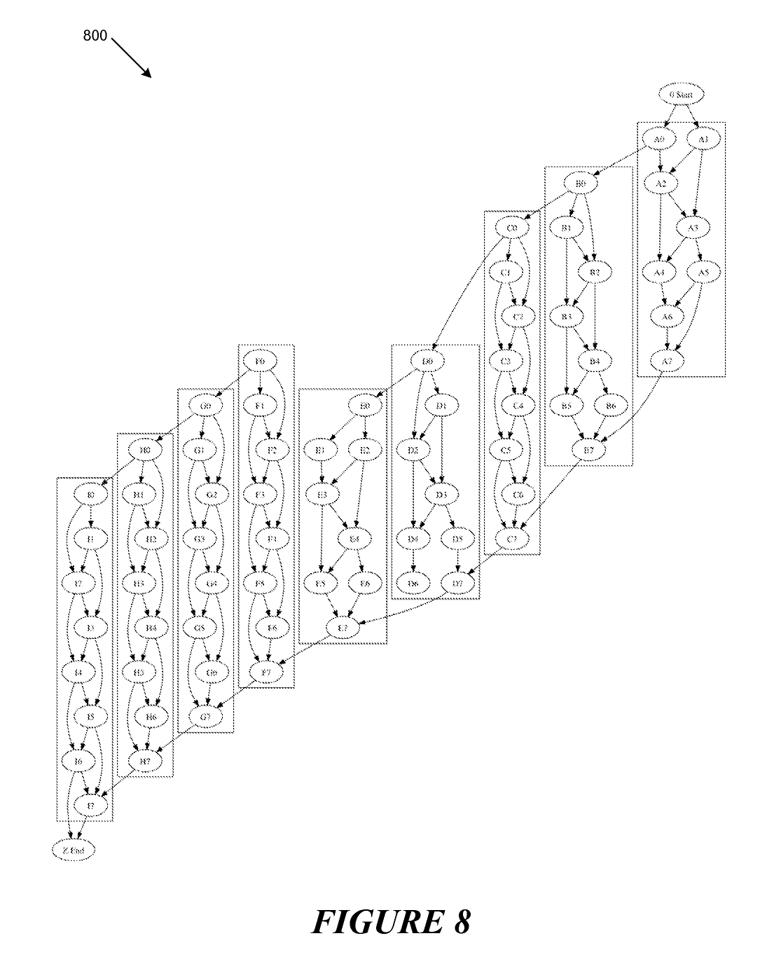

FIG. 8 shows still yet another grouping of the individual items depicted in the simplified graph of FIG. 4 into a plurality of subgraphs implemented in accordance with an embodiment of the invention. In this embodiment, the essence of the positional data is captured and expressed from a mathematical perspective through the implementation of the following algorithm.

{-# LANGUAGE OverloadedStrings #-}
import Data.GraphViz
import Data.GraphViz.Attributes
import Data.GraphViz.Types.Canonical
import qualified Data.List as L
import System.Random
-- Defines a Node
data Node = Node {

| | |
|---|---|
| nodeName | :: String, |
| col | :: Int, |
| row | :: Int |

} deriving (Eq, Show)

-- Encapsulates a node with the time difference to step between
data NodeStep = NodeStep {

| | |
|---|---|
| node | :: Node, |
| nodePrev | :: Node, |
| timeStep | :: Double, |
| timeTotal | :: Double |

} deriving (Eq, Show)

-- Setup our standard generator
gen = mkStdGen 42
-- Variables to control the shopping list
maxCol = 7
maxRow = 8 -- Do not exceed 24
yCol = [‘A’..‘Y’]
-- A picture of the nodes (without node data) arranged in groups by

either row or column

genNodeRows = [map (yCol !! y:) [show x| x <− [0..maxCol]] | y <−

[0..maxRow]]

-- A list of all nodes to feed to the randomizer
flatNodes = [Node (yCol !! y:show x) y x | x <− [0..maxCol], y <−

[0..maxRow]]

-- Special nodes
startNode = Node “0 Start” (−1) (−1)
endNode = Node “Z End” (maxRow + 1) (maxCol + 1)
-- Convert a list of Nodes into Nodesteps
getNodeList :: [Int] −> [NodeStep]
getNodeList l = getNodeTimes (makeNodeList l) startNode 0.0
-- Get a NodeStep for a Node
getNodeTimes :: [Node] −> Node −> Double −> [NodeStep]

| | | | |
|---|---|---|---|
| getNodeTimes [ ] | _ | _ | = [ ] |

getNodeTimes (n:ns) oldN lastTime = getNodeStep n oldN lastTime :

getNodeTimes ns n (lastTime + timeDelta n oldN)

-- Convert a list of integers into Nodes
makeNodeList :: [Int] −> [Node]
makeNodeList l = map (flatNodes !!) l ++ [endNode]
-- Construct a NodeStep from the applicable information
getNodeStep :: Node −> Node −> Double −> NodeStep
getNodeStep n oldN l = NodeStep n oldN (timeDelta n oldN) (l + timeDelta

n oldN)

n1 = Node “H7” 7 7
n2 = Node “I7” 8 7
-- Utility function for calculating a time delta
timeDelta :: Node −> Node −> Double

| timeDelta n oldN = let currentX | | = fromIntegral (col n) |
|---|---|---|
| | currentY | = fromIntegral (row n) |
| | lastX | = fromIntegral (col oldN) |
| | lastY | = fromIntegral (row oldN) |
| | mY | = fromIntegral (maxRow − 1) |
| | mH | = fromIntegral (floor (fromIntegral |

(maxRow) / 2.0) − 1)

in if currentX == lastX

```
  then 5.0 * abs (currentY − lastY)
  else 10.0 * abs (currentX − lastX)
  + if lastY < mH
  then 5.0 * (lastY + currentY)
  else 5.0 * ((mY − lastY) + (mY − currentY))
```

-- The features in this graph are common to any graph produced - edges

change from start to finish

getStartGraph :: [DotSubGraph String] −> [DotEdge String] −> DotGraph

String

getStartGraph subGraphs edges = DotGraph {

```
  strictGraph = False,
  directedGraph = True,
  graphID = Just (Str “G”),
  graphStatements = DotStmts {
```

```
  attrStmts = [ ],
  subGraphs = subGraphs,
  nodeStmts = [ DotNode (nodeName startNode) [ ],
```

DotNode (nodeName endNode) [ ] ],

edgeStmts = edges

```
    }
  }
```

-- Produce all the subgraphs
subGraphAll :: [DotSubGraph String]
subGraphAll = subGraphClusters genNodeRows 0
-- Produce DotSubGraphs recursively and increment a counter for the

cluster ID

subGraphClusters :: [[String]] −> Int −> [DotSubGraph String]

| | |
|---|---|
| subGraphClusters [ | ] _ = [ ] |

subGraphClusters (x:xs) i = subGraphCluster x i : subGraphClusters xs (i

+ 1)

-- Produce a DotSubGraph cluster for a row (or column) of nodes.
subGraphCluster :: [String] −> Int −> DotSubGraph String
subGraphCluster nodes i = DotSG {

isCluster = True,
subGraphID = Just (Int i),
subGraphStmts = DotStmts {

```
  attrStmts = [ ],
  subGraphs = [ ],
  nodeStmts = [DotNode n [ ] | n <−
```

nodes ],

```
  edgeStmts = [ ]
  }
```

}

-- Produce a list of optimal paths based upon known spatial data
idealEdges :: [DotEdge String]
idealEdges = [DotEdge (nodeName startNode) (head (head genNodeRows)) [ ]]

++ concat (idealEdgesRows genNodeRows)
++ concat idealEdgesCols
++ [DotEdge (last (last genNodeRows)) (nodeName endNode)

[ ]]

-- Build the ideal paths along the ends of the rows
idealEdgesCols :: [[DotEdge String]]
idealEdgesCols = idealEdgesRows [head (L.transpose genNodeRows) , last

(L.transpose genNodeRows)]

-- Build all the ideal rows
idealEdgesRows :: [[String]] −> [[DotEdge String]]

| | |
|---|---|
| idealEdgesRows [ | ] = [ ] |

idealEdgesRows (x:xs) = idealEdgesRowList x : idealEdgesRows xs
-- Build an ideal row
idealEdgesRowList :: [String] −> [DotEdge String]
idealEdgesRowList (x:y:xs) = DotEdge x y [ ] : idealEdgesRowList (y:xs)

| | |
|---|---|
| idealEdgesRowList _{—} | = [ ] |

-- Iterate through the lists...
edgesAll :: [[NodeStep]] −> [[DotEdge String]]
edgesAll (x:xs) = edgesList x : edgesAll xs
edgesAll _ = [ ]
-- ...to build the edges
edgesList :: [NodeStep] −> [DotEdge String]
edgesList (x:xs) = dotEdge x : edgesList xs
edgesList _ = [ ]
-- DotEdge utilities
dotEdge :: NodeStep −> DotEdge String
dotEdge x = DotEdge (nodeName (nodePrev x)) (nodeName (node x)) [ ]
dotEdgeSort :: NodeStep −> DotEdge String
dotEdgeSort x = let ns = L.sort [nodeName (nodePrev x), nodeName (node

x)]
in DotEdge (head ns) (last ns) [ ]

-- Variables to control the randomized lists
minLen = 5
maxLen = 10
numLists = 1000
-- Produce N ints between min and max for our shopping needs
randListInRange :: StdGen −> Int −> Int −> Int −> [Int]
randListInRange _ 0 _ _ = [ ]
randListInRange gen n minN maxN = let (a, gen2) = randomR (minN, maxN)

gen

in a : randListInRange gen2 (n − 1)

minN maxN

-- Utilies using randListInRange
allListLens :: [Int]
allListLens = randListInRange gen numLists minLen maxLen
allListItems :: [Int]
allListItems = randListInRange gen (sum allListLens) 0 maxIndexOfNodes
maxIndexOfNodes = (maxCol + 1) * (maxRow + 1) − 1
-- Produce nested lists of items from the list lengths and items
allLists :: [Int] −> [Int] −> [[NodeStep]]

| | |
|---|---|
| allLists [ | ] _ = [ ] |

allLists (x:xs) itms = let (h, t) = splitAt x itms

in getNodeList h : allLists xs t

-- Process all lists
procLists :: [[NodeStep]] −> [DotEdge String]

| | |
|---|---|
| procLists [ | ] = [ ] |

```
procLists (x:xs) = procList x ++ procLists xs
-- Process a given list of NodeSteps
-- - Note that we're doing a sort on edges here just to prevent two
arrows on directional graphs
procList :: [NodeStep] −> [DotEdge String]
procList [ ] = [ ]
procList (x:xs) = dotEdgeSort x : procList xs
-- These are utilities for processing the data into optimized forms
-- Produce all the lists in NodeStep format
allSteps = allLists allListLens allListItems
flatSteps = concat allSteps
-- Graph a subset of lists in all their glory
limitPreNoGroups n = concat (edgesAll (take n allSteps))
-- Filter by length only
lengthFilter = filter stepSize flatSteps
main :: IO ( )
main = do
  putStrLn “Start”
  -- A sample list
  putStrLn $ unlines [“List:\n” ++ unlines (map show x) | x <− take 10 $
```

allSteps]

```
  -- Graphs of the original data
  produceOutput “1outputNormalized.png” subGraphAll idealEdges
  produceOutput “2outputPreNoGroups.png” [ ] $ limitPreNoGroups 8
  produceOutput “3outputPreGroups.png” subGraphAll $ limitPreNoGroups 8
  produceOutput “4outputPreEverything.png” subGraphAll $ idealEdges ++
```

limitPreNoGroups 8

```
  -- Post processing (simple
  produceOutput “5outputPostSimpleLength.png” [ ] $ procList lengthFilter
  produceOutput “6outputPostSimpleLengthAll.png” subGraphAll $procList
```

lengthFilter

-- results <− procListsSeq allSteps stepTooLarge’
-- putStrLn $ “total: ” ++ show (length (L.nub (concat results))) ++ “

results”

-- produceOutput “5outputPostSimpleLength.png” [ ] (concat results)
putStrLn “All done!”
-- Data processing logic
stepSize x = timeStep x > 0 && timeStep x < sqrt 225

As a result, the majority of the subgraphs 800 accurately depict the order of the items within each of the aisles ‘A’ through ‘I’ 304 depicted in FIG. 3. While the implementation of this algorithm does not result in a perfect depiction, discrete aisles are visible, particularly aisles ‘C’, and ‘F’ through ‘I’. However, the algorithm does not appear to have determined that items ‘D4’ and ‘D5’ are next to one another although they are by definition. Nonetheless, they are still represented within the subgraphs 800 as relatively close. Imposing knowledge of the aisles ‘A’ through ‘I’ 304 depicted in FIG. 3 further clarifies the arrangement and depiction of the subgraphs 800. It will be appreciated that while errors are present in the subgraphs 800, the overall depiction is useful in obtaining an understanding of the data contained therein.

It will likewise be appreciated that the implementation of the randomized lists described in greater detail herein are truly random and take no advantage of the intelligence a human would typically apply in a real-world scenario. Furthermore, the number of lists needed to accurately depict the items within the subgraphs 800 would likely decrease as the users shoppers would typically locate the items on their list in a time-efficient manner. Moreover, even if a given user did not have knowledge of a predetermined physical site, they would generally realize that similar items (e.g., apples, oranges and other fruit) would be proximal while dissimilar items (e.g., bread and bath soap) are unlikely to be proximal to one another.

From the foregoing, it will be appreciated that the graph information depicted in the subgraphs 800 could be converted into other useful expressions in various ways. For example, human-friendly descriptions could be provided to a user of an intelligent application implemented on a mobile device. To further the example, if the user asks where the bananas are, the mobile device may be able to respond that they are near the cherries the user just located. Such an application could apply graph techniques to assist in navigation, or in a shopping metaphor, simply organize items in the order a shopper would be able to locate them most quickly. Other sorts of user-driven navigation scenarios are easily imagined, such as item picking in warehouses.

Likewise, by implementing coordinates at the edges of the graph, a computing device may be able to produce approximate coordinates for other items based upon making various assumptions of locations of items relative to other items in the graph. It will be appreciated that the ability to produce approximate coordinates calculated from fuzzier, human-instrumented data collection might be desirable in situations where robots need to interact with humans.

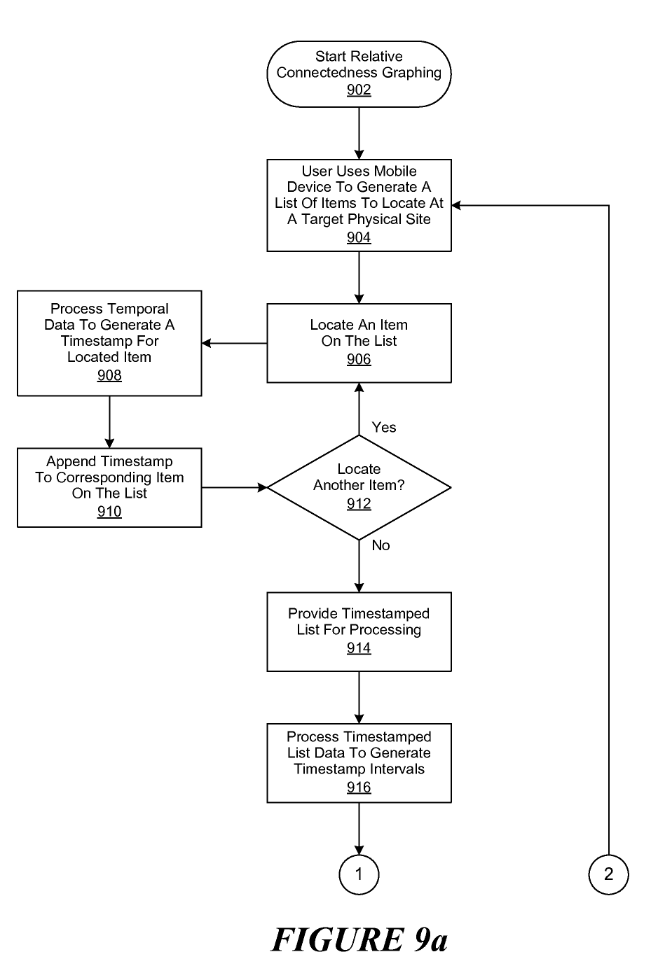

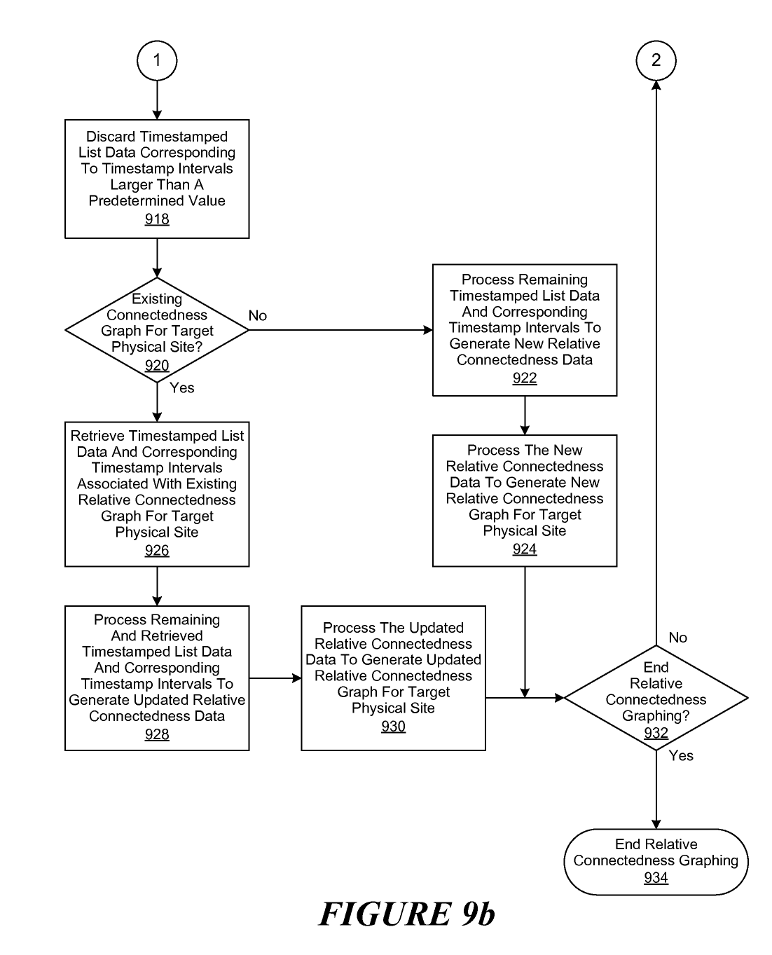

FIGS. 9a and 9b are a generalized flowchart of operations implemented in accordance with an embodiment of the invention for performing relative connectedness graphing operations. In this embodiment, relative connectedness graphing operations are begun in step 902, followed by a user using a mobile device in step 904 to generate a list of items to locate in a target physical site. An item on the list is then located by the user in step 906, followed by processing temporal data to generating a timestamp for the located item in step 908 as described in greater detail herein.

The resulting timestamp is then appended to the corresponding item on the list in step 910, followed by a determination being made in step 912 whether to locate another item on the list. If so, the process is continued, proceeding with step 906. Otherwise, the timestamped list is provided for processing in step 914. Timestamped list data is then processed in step 916, as described in greater detail herein, to generate timestamp intervals. Timestamped list data corresponding to timestamp intervals larger than a predetermined value, as likewise described in greater detail, is then discarded in step 918.

A determination is then made in step 920 whether a relative connectedness graph currently exists for the target physical site. If not, then the remaining timestamped list data and corresponding timestamp intervals are processed in step 922 to generate new relative connectedness data, which in turn is processed on step 924 to generate a new relative connectedness graph for the target physical site. Otherwise, timestamped list data and corresponding timestamp intervals associated with an existing relative connectedness graph is retrieved for the target physical site in step 926. The remaining and retrieved timestamped list data, along with corresponding timestamp intervals, are then processed in step 928 to generate updated relative connectedness data, which in turn is processed in step 930 to generate an updated relative connectedness graph for the target physical site. Once the new or updated relative connectedness graph is respectively generated in step 924 or 930, a determination is made in step 932 whether to end relative connectedness graphing operations. If not, then the process is continued, proceeding with step 904. Otherwise, relative connectedness graphing operations are ended in step 934.

Although the present invention has been described in detail, it should be understood that various changes, substitutions and alterations can be made hereto without departing from the spirit and scope of the invention as defined by the appended claims.

1-7. (canceled)

8. A system comprising:
a processor;
a data bus coupled to the processor; and
a computer-usable medium embodying computer program code, the computer-usable medium being coupled to the data bus, the computer program code used for determining relative connectedness from temporal data and comprising instructions executable by the processor and configured for:
receiving a first set of timestamped list data corresponding to a first set of items located at a physical site;
processing the first set of timestamped list data to generate a first set of timestamp interval data corresponding to individual items in the first set of items; and
processing the first set of timestamped list data and the first set of timestamp interval data to generate a first set of relative connectedness data corresponding to the relative physical proximity of the individual items in the first set of items to one another.

9. The system of claim 8, further comprising:
processing the first set of relative connectedness data to generate a first relative connectedness graph of the first set of items;
processing the first relative connectedness graph to generate a first set of coordinates for each of the individual items in the first set of items; and
using the first set of coordinates to generate a first spatial map of the first set of items.

10. The system of claim 9, further comprising:
receiving a second set of timestamped list data corresponding to a second set of items located at the physical site;
processing the second set of timestamped list data to generate a second set of timestamp interval data corresponding to individual items in the second set of items; and
processing the first and second sets of timestamped list data and the first and second sets of timestamp interval data to generate a second set of relative connectedness data corresponding to the relative proximity of the individual items in the first and second sets of items.

11. The system of claim 10, further comprising:
processing the second set of relative connectedness data to generate a second relative connectedness graph of the first and second sets of items.
processing the second relative connectedness graph to generate a second set of coordinates for each of the individual items in the first and second sets of items; and
using the second set of coordinates to generate a second spatial map of the first and second sets of items.

12. The system of claim 11, wherein:
the first set of timestamped list data comprises a first set of temporal data corresponding to when individual items in the first set of items are located by a first user, the first set of timestamped list data provided by a first mobile device associated with the first user; and
the second set of timestamped list data comprises a second set of temporal data corresponding to when individual items in the second set of items are located by a second user, the second set of timestamped list data provided by a second mobile device associated with the second user.

13. The system of claim 12, further comprising:
processing the first set of timestamp interval data to generate a third set of timestamped list data and a third set of timestamp interval data corresponding to timestamp intervals having a duration shorter than a predetermined timestamp interval value; and
processing the third set of timestamped list data and the third set of timestamp interval data to generate a third relative connectedness graph of the first set of items;
processing the third relative connectedness graph to generate a third set of coordinates for each of the individual items in the first set of items; and
using the third set of coordinates to generate a third spatial map of the first set of items.

14. The system of claim 13, further comprising:
processing the second set of timestamp interval data to generate a fourth set timestamped list data and a fourth set of timestamp interval data corresponding to timestamp intervals having a duration shorter than a predetermined timestamp interval value.
processing the third and fourth sets of timestamped list data and the third and fourth sets of timestamp interval data to generate a fourth relative connectedness graph of the first and second sets of items;
processing the fourth relative connectedness graph to generate a fourth set of coordinates for each of the individual items in the first and second sets of items; and
using the fourth set of coordinates to generate a fourth spatial map of the first and second sets of items.

15. A non-transitory, computer-readable storage medium embodying computer program code, the computer program code comprising computer executable instructions configured for:
receiving a first set of timestamped list data corresponding to a first set of items located at a physical site;
processing the first set of timestamped list data to generate a first set of timestamp interval data corresponding to individual items in the first set of items; and
processing the first set of timestamped list data and the first set of timestamp interval data to generate a first set of relative connectedness data corresponding to the relative physical proximity of the individual items in the first set of items to one another.

16. The non-transitory, computer-readable storage medium of claim 15, further comprising:
processing the first set of relative connectedness data to generate a first relative connectedness graph of the first set of items;
processing the first relative connectedness graph to generate a first set of coordinates for each of the individual items in the first set of items; and
using the first set of coordinates to generate a first spatial map of the first set of items.

17. The non-transitory, computer-readable storage medium of claim 16, further comprising:
receiving a second set of timestamped list data corresponding to a second set of items located at the physical site;
processing the second set of timestamped list data to generate a second set of timestamp interval data corresponding to individual items in the second set of items; and
processing the first and second sets of timestamped list data and the first and second sets of timestamp interval data to generate a second set of relative connectedness data corresponding to the relative proximity of the individual items in the first and second sets of items.

18. The non-transitory, computer-readable storage medium of claim 17, further comprising:
processing the second set of relative connectedness data to generate a second relative connectedness graph of the first and second sets of items.
processing the second relative connectedness graph to generate a second set of coordinates for each of the individual items in the first and second sets of items; and
using the second set of coordinates to generate a second spatial map of the first and second sets of items.

19. The non-transitory, computer-readable storage medium of claim 18, wherein:
the first set of timestamped list data comprises a first set of temporal data corresponding to when individual items in the first set of items are located by a first user, the first set of timestamped list data provided by a first mobile device associated with the first user; and
the second set of timestamped list data comprises a second set of temporal data corresponding to when individual items in the second set of items are located by a second user, the second set of timestamped list data provided by a second mobile device associated with the second user.

20. The non-transitory, computer-readable storage medium of claim 19, further comprising:
processing the first set of timestamp interval data to generate a third set of timestamped list data and a third set of timestamp interval data corresponding to timestamp intervals having a duration shorter than a predetermined timestamp interval value;
processing the third set of timestamped list data and the third set of timestamp interval data to generate a third relative connectedness graph of the first set of items;
processing the third relative connectedness graph to generate a third set of coordinates for each of the individual items in the first set of items; and
using the third set of coordinates to generate a third spatial map of the first set of items.

21. The non-transitory, computer-readable storage medium of claim 20, further comprising:
processing the second set of timestamp interval data to generate a fourth set timestamped list data and a fourth set of timestamp interval data corresponding to timestamp intervals having a duration shorter than a predetermined timestamp interval value;
processing the third and fourth sets of timestamped list data and the third and fourth sets of timestamp interval data to generate a fourth relative connectedness graph of the first and second sets of items;
processing the fourth relative connectedness graph to generate a fourth set of coordinates for each of the individual items in the first and second sets of items; and
using the fourth set of coordinates to generate a fourth spatial map of the first and second sets of items.
